(19) United States
(12) Patent Application Publication
(10) Pub. No.: US 2011/0259869 A1
(43) Pub. Date: Oct. 27, 2011

(54) COOKING APPARATUS WITH NON-METAL PLATES

(76) Inventor: Penny Hlavaty, Queensland (AU)

(21) Appl. No.: 13/129,189

(22) PCT Filed: Nov. 16, 2009
(86) PCT No.: PCT/AU2009/001490

§ 371 Date: Jul. 14, 2011

(30) Foreign Application Priority Data
Nov. 14, 2008 (AU) 2008905883

(51) Int. Cl. F27D 11/00

(52) U.S. Cl. 219/385

(57) ABSTRACT

The invention is directed to a cooking apparatus including two non-metal plates, each of which has a non-metal platen and an integral or bonded thin film element. The non-metal platen is made from material selected from nano-ceramic, pyroceramic glass, ceramic reinforced with silicon carbide, silicon carbide or mica composite. Each of the plates are mounted in a frame having an upper portion pivotally mounted to a lower portion with the non-metal platens opposing each other. There is also a control means for controlling the electrical current to the thin film elements and the plates can be heated to temperatures between 300° C. and 450° C. to provide even cooking of the food product while providing energy efficiencies.

### FIELD OF INVENTION

The present invention relates to cooking apparatus and in particular to hotplate grills for cooking food. The present invention has particular but not exclusive application for domestic and commercial operations. Reference to contact grills in the specification is by way of example only and the invention is not limited to this example.

### BACKGROUND OF THE INVENTION

Contact grills are used in casual dining and fast food outlets where speed and consistence in the quality of the cooked food product are important. While contact grills are relatively efficient compared with other forms of cooking, large amounts of energy are required to heat and maintain the temperature of the metal hotplates.

Conventional contact grills have an upper thick metal plate hinged to a lower thick metal plate. Both plates are usually heated via an electric element. Because of their thickness, the plates take time to heat up and retain their residual heat even after power to the grill plates has been turned off. The plates are relatively thick to avoid warping with high temperatures but with thick plates large amounts of energy are used.

Furthermore, relatively high temperatures, that is temperatures above 300° C., using far-infrared radiation is desirable as the entire piece of food is cooked evenly before the outer portion is overcooked. High temperature hotplates have been developed by coating the plates with a combination of polytetrafluoroethylene (PTFE) and ceramic material on metal plates (U.S. Pat. No. 5,722,315). This coating however has problems because it gasses off over at temperatures over 260 degrees Celsius and is relatively inefficient from an energy perspective.

### OBJECT OF THE INVENTION

It is an object of the present invention to provide an alternate cooking apparatus that overcomes at least in part one or more of the above mentioned problems.

### SUMMARY OF THE INVENTION

The present invention arises from an alternative approach of heating hotplates directly from electrical elements of low thermal mass rather than rely on the build up and maintenance of residual heat in the plates. Also, with the understanding that borosilicate or pyrex glass in cooktops cannot withstand high operating temperatures and fluctuating heat loads because thermal fatigue causes devitrification and thin film electrodes cannot bond to a metal surface and the knowledge of developments in the fields of materials science and electrical elements, the inventor selected suitable materials and designed a cooking apparatus that has improved energy efficiencies and cooks at relatively high temperatures.

In one aspect the present invention broadly resides in a cooking apparatus including

two non-metal plates operatively associated with each other, each non-metal plate has a non-metal platen and an integral or bonded thin film element, the non-metal platen is made from material selected from nano-ceramic, pyroceramic glass, ceramic reinforced with silicon carbide, silicon carbide or mica composite;

a frame having an upper portion pivotally mounted to a lower portion, each of said portions supports one of said non-metal plates wherein in use the non-metal platens oppose each other; and

control means for controlling the electrical current to the thin film element, wherein the plates can heat to temperatures between 300° C. and 450° C.

The non-metal plates are preferably thinner plates compared with metal plates that can be heated to temperatures between 300° C. and 450° C. The non-metal plates preferably have a thickness 2 to 12 mm.

The nano-ceramic plates preferably have a black nanoglaze that provides a non-stick surface. The nano-ceramic plates are preferably 2 to 6 mm thick.

The pyroceramic glass plate is preferably a low alkaline glass with a thickness between 2 and 6 mm.

The ceramic reinforced with silicon carbide plates, silicon carbide plates and mica plates are preferably 4 to 6 mm thick.

The platen upper surface can have any suitable design including rib and waffle patterns.

The thin film element is preferably graphite or some other conductive material contained between non-conductive layers. The element can be positioned as a series of ribs connected by bus bars or a ribbon configuration. The thin film element is preferably planar in position.

In one embodiment the thin film element is preferably replaceable. The thin film element is preferably replaced by positioning the new thin film element against the rear surface of the plate and using mechanical pressure to ensure direct contact with the platen without an air gap. Preferably there is one or more insulation layer(s) between the thin film element and the platen.

The plates are preferably operatively associated with each other by a pivot or hinge arrangement. The upper plate preferably lifts up and then pivots back.

The frame preferably has grooves or rails surrounding or partially surrounding a recess for mounting the plates. Preferably there is a recess in each portion.

Preferably there is a high temperature gasket between the plate and the frame to accommodate small variations in plate size and prevent heating of the frame. Preferably the high temperature gasket is made of silicon.

In one preferred embodiment, each of the plates are interchangeable thereby allowing for replacement of plates that are faulty or placement of special purpose plates. The plates can preferably slide or be placed in position within the frame.

In another aspect the present invention broadly resides in a cooking apparatus including

two non-metal plates pivotally attached to each other, each non-metal plate has a non-metal platen and an integral or bonded thin film element, the non-metal platen is made from material selected from nano-ceramic, pyroceramic glass, ceramic reinforced with silicon carbide, silicon carbide or mica composite, each of said plates is replaceable, each of said plates has a groove or rail around its periphery;

a frame having an upper portion pivotally mounted to a lower portion, each of said portions supports one of said non-metal plates wherein in use the non-metal platens oppose each other; each of said portions has a recess and complementary groove or rail surrounding or partially surrounding the recess for mounting the plates; and

control means for controlling the electrical current to the thin film element, wherein the plates can heat to temperatures between 300° C. and 450° C.

The plates are preferably mounted by sliding the plate in position by a tongue and groove arrangement or positioning the plate on a rail surrounding or partially surrounding the recess within the portions.

Preferably the plates or the periphery of the frame recesses has a shield that forms a space for cavity between the plates when they are closed. The shield preferably serves to reflect heat and/or redirect fluid. The shield in the plates is preferably integrated and forms an upright edge around a plurality of sides. The shield in the plates preferably extends around a plurality of sides and has a height of up to 4 mm. In an alternative embodiment, a high temperature gasket such as a silicon gasket, is positioned around the periphery of the frame recesses and forms a shield to reflect heat and redirect fluid.

There may be one or more optional shields that can be placed on or in association with the plates to define a cavity that can serve as an oven. These optional shields can be of varying heights and be made of materials that reflect heat within the cavity. There is preferably a stainless steel shield having a rectangular shape that fits within the outer edge of the plates and has a height of 100 mm to 150 mm. Alternatively, the optional shields can be made of suitable ceramic glass or other infra-red emitting material that reflects lower temperature (longer wavelengths of radiation) which warms rather than cooks the food in the cavity.

The cooking apparatus may also have washing means. Washing means preferably includes a channel on the rear of the plate, front of the plate or between a series of plates and a spray jet that can spray water into the enclosed cavity of the cooking apparatus onto the plates of a closed cooking apparatus. The channels are preferably connected to the plumbed waste water system. The spray jet preferably sprays in a flat fanned shape and the water is converted into steam on the surface of the plates removing carbonized matter and condensing to water before draining to the channel. The channel is preferably only on one side of each plate. Water is prevented from escaping because the surrounding shields enclose the space and water is directed to the adjacent channels. Preferably, a minimum amount of water is required and the platens are heated to 120° C. to 150° C. to efficiently convert the water to steam.

In another preferred embodiment, the plates preferably have a platen and a thin film heating element on each side so that the plates can be removed and reversed when a different platen is required or the thin film element is faulty. Preferably the plate comprises of the following layers: a platen, a thin film heating element, laminated insulation in a mirror image format using thin firm reflectors, thin film heating element, and platen.

Preferably, the cooking apparatus forms a modular unit and can be joined with other cooking apparatus in different configurations to suit kitchen requirements. In this way, a plurality of cooking apparatus may be joined to meet the demands for cooked food.

In a further aspect, the present invention preferably resides in a cooking system including one or more cooking apparatus as described above in a modular arrangement to meet kitchen demands.

### BRIEF DESCRIPTION OF THE DRAWINGS

In order that the present invention can be more readily understood reference will now be made to the accompanying drawings which illustrate a preferred embodiment of the invention and wherein:

FIG. 1 is a diagrammatic view of a bench top cooking apparatus:

FIG. 2 is a diagrammatic side view of the bench top cooking apparatus:

FIG. 3 is a diagrammatic view of the bench top cooking apparatus in an open position:

FIG. 4 is a diagrammatic view of the bench top cooking apparatus in an open position showing the positioning of the lower plate:

FIG. 5a and FIG. 5b are waffle and rib pattern plates respectively:

FIG. 6 is a diagrammatic view of the bench top cooking apparatus in a partial opened position:

FIG. 7 is a diagrammatic top view of the bench top cooking apparatus:

FIG. 8 is a cross-sectional view (A-A) of the bench top cooking apparatus:

FIG. 9 is a diagrammatic view of two cooking apparatus set in the bench:

FIG. 10 is a diagrammatic top view of the two cooking apparatus set in the bench:

FIG. 11 is another diagrammatic view of the two cooking apparatus set in the bench:

FIG. 12 is a cross-sectional view (B-B) of the cooking apparatus set in the bench:

FIG. 13 is a partial cross-sectional view (C-C) of the cooking apparatus set in the bench:

FIG. 14 is a diagrammatic perspective view of a ribbed plate:

FIG. 15 is a diagrammatic view of the underside of the ribbed plate:

FIG. 16 is a conceptual view of the plate arrangement:

FIG. 17 is a photograph of a bench top cooking apparatus used as an oven:

FIG. 18 is a diagrammatic view of the layers of a thin film element; and

FIG. 19 is a photograph of a loaf of bread baking in a bench top cooking apparatus:

### DETAILED DESCRIPTION OF THE PREFERRED EMBODIMENTS

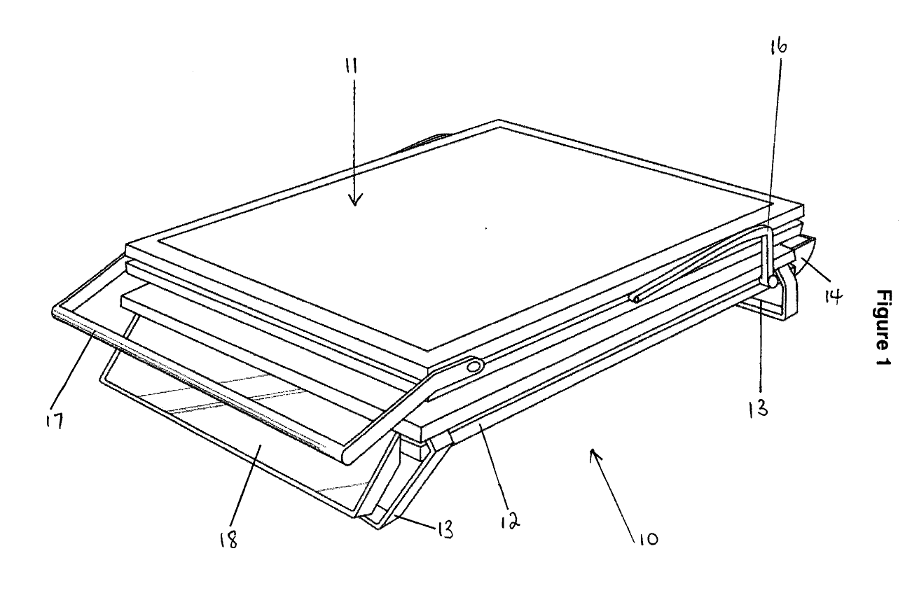

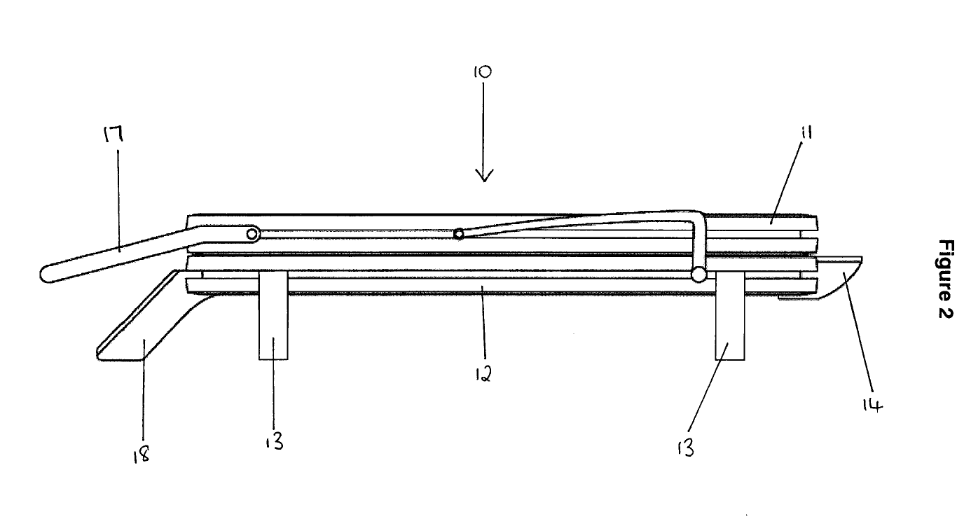

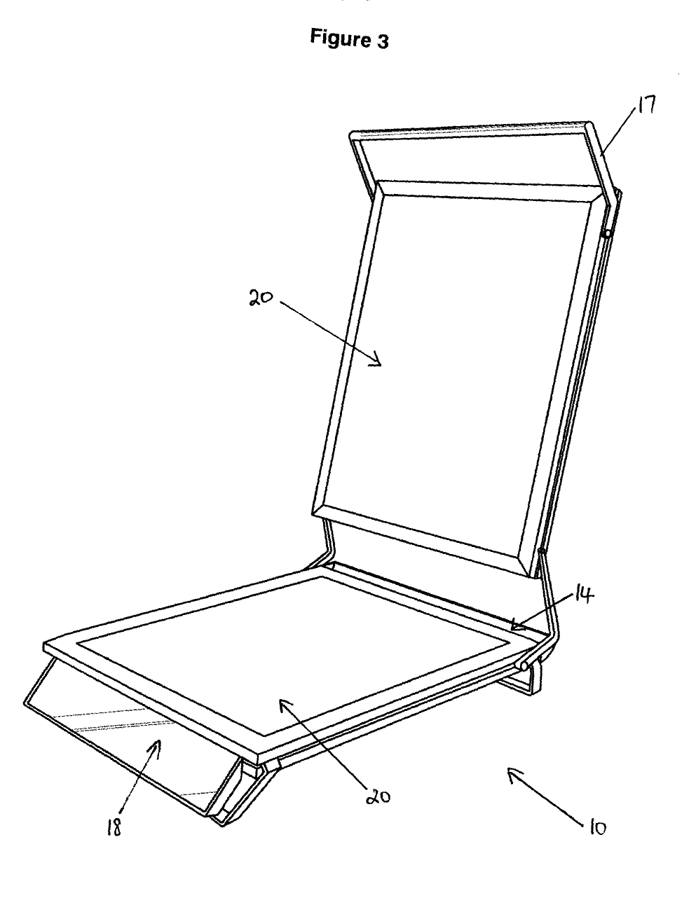

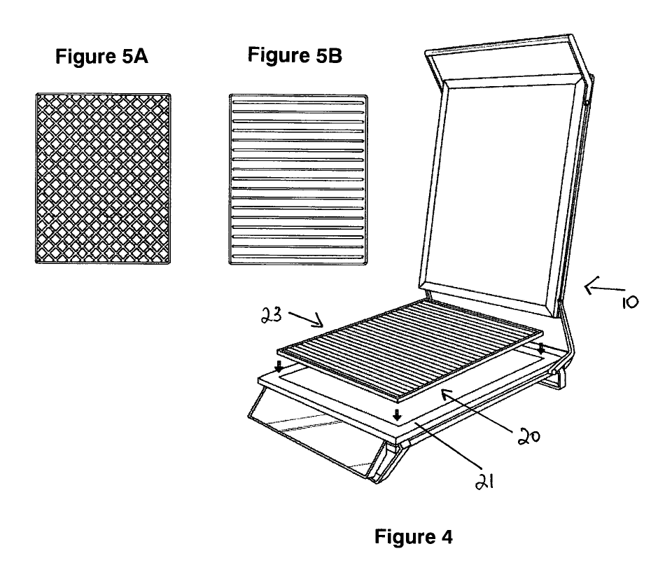

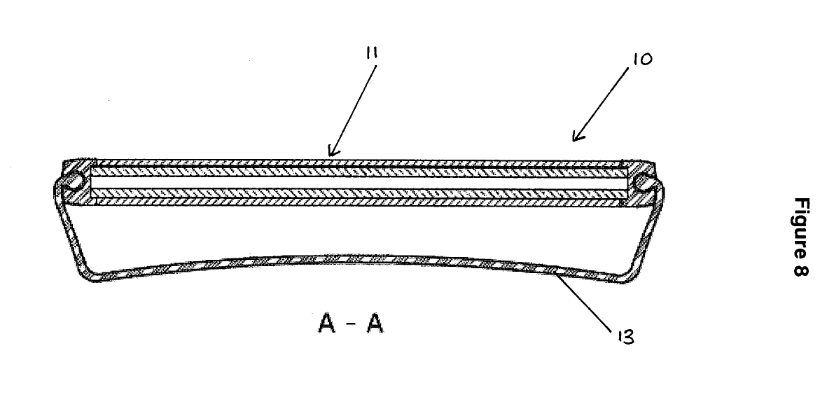

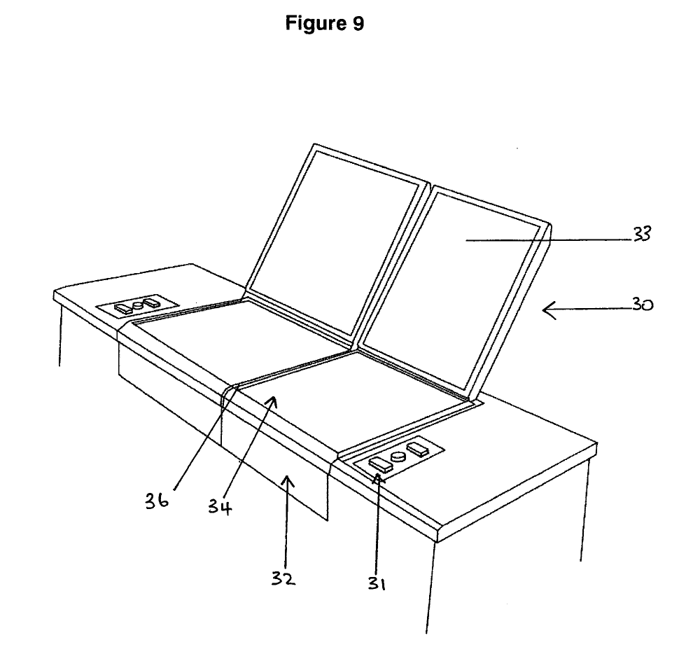

With respect to FIGS. 1 to 8, there is shown a bench top cooking apparatus 10, having an upper plate frame 11, lower plate frame 12, feet 13, a drain channel 14 at the rear side of the cooking apparatus and a hinged 16 on either side of the cooking apparatus 10 and connecting the upper plate frame 11 with the lower plate frame 12. There is a handle 17 attached to the upper plate frame 11 at the front of the cooking apparatus 10. There is also an optional drain channel 18 positioned at the front of the cooking apparatus 10.

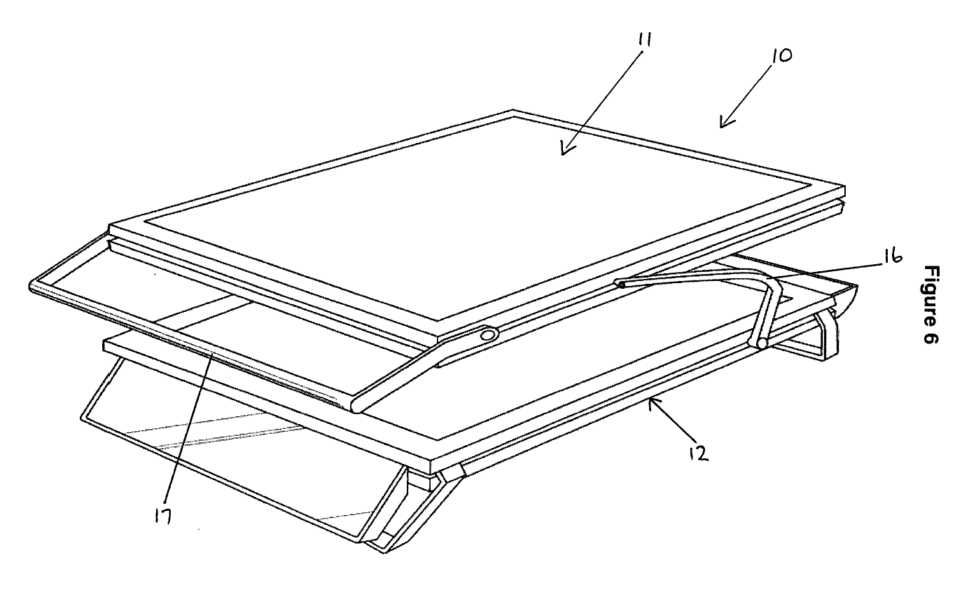

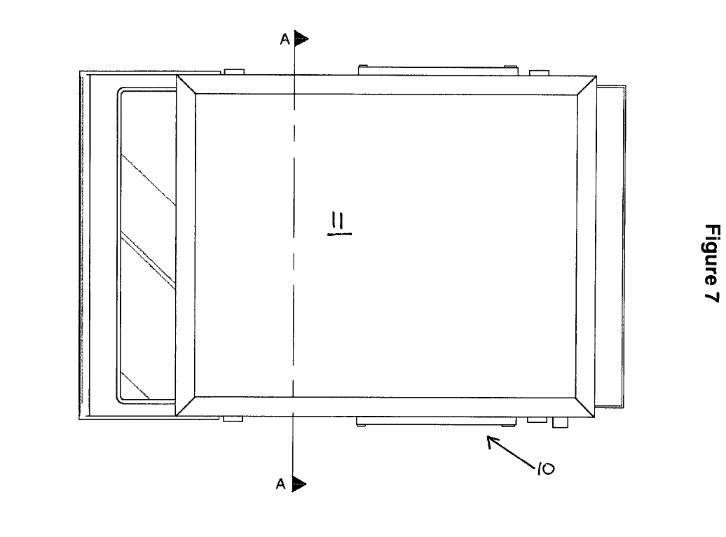

In the open position the bench top cooking apparatus 10 has a recess 20 in the lower plate frame 12 and in the upper plate frame 11. Plates 23 can be positioned by resting on rails surrounding two or more sides of the periphery 21 of the recesses 20 or sliding into position through a rail and groove arrangement. FIG. 5a shows a plate with a waffle pattern while FIG. 5b shows a plate with a ribbed pattern.

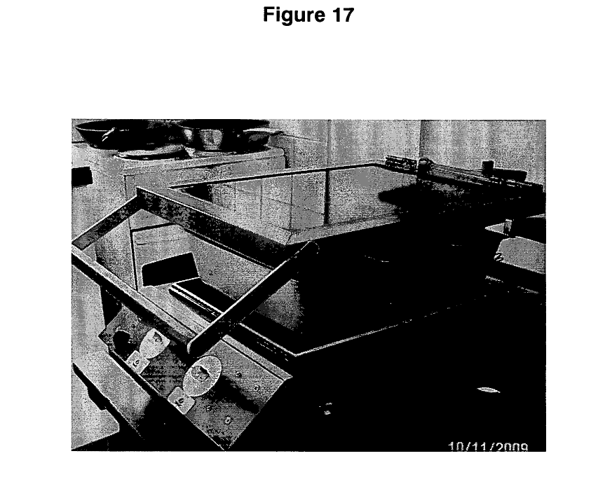

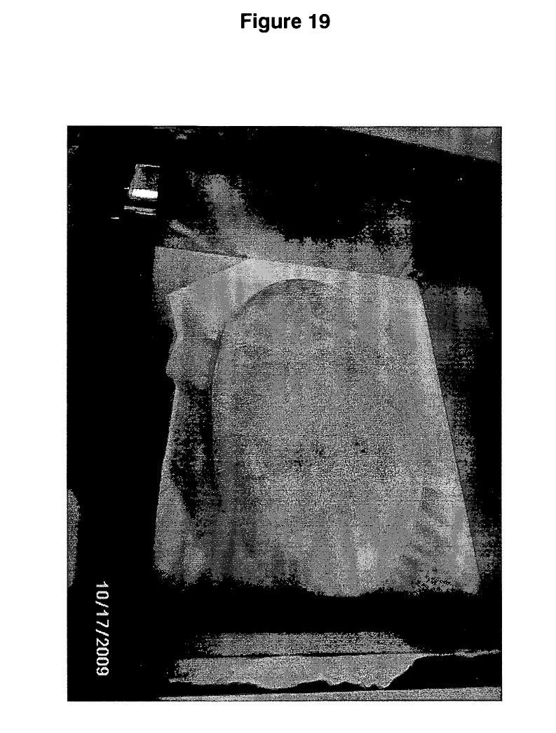

The hinge 16 allows the plates to be opposing and spaced apart from each other in order to serve as an oven. The hinge 16 can also open and close to form a char grill or contact grill. FIGS. 17 and 19 show the use of cooking apparatus as an oven to bake bread. Between the plates is a rectangular stainless steel shield to reflect heat within the enclosed space.

The periphery 21 of the recess 20 is raised and serves to enclose a space between the plates 23.

During cooking any waste is collected in the drain channel 14.

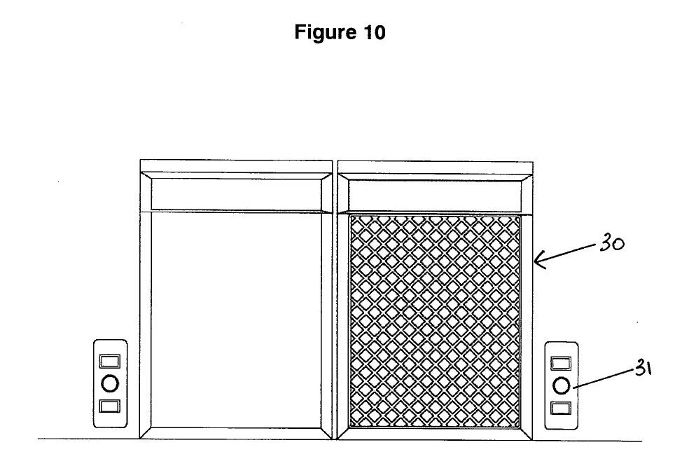

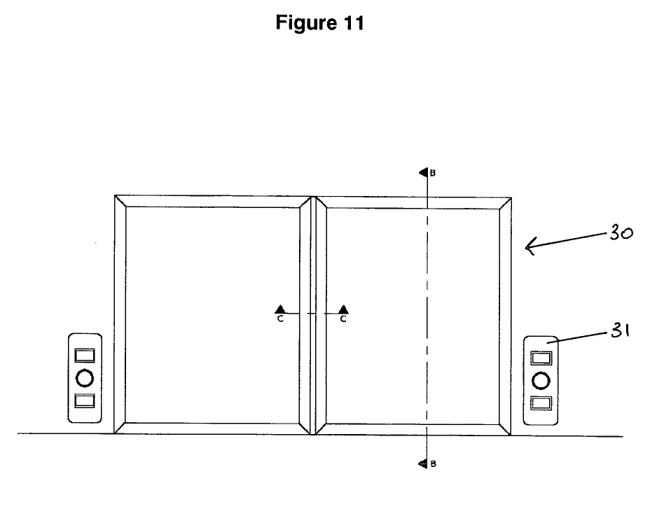

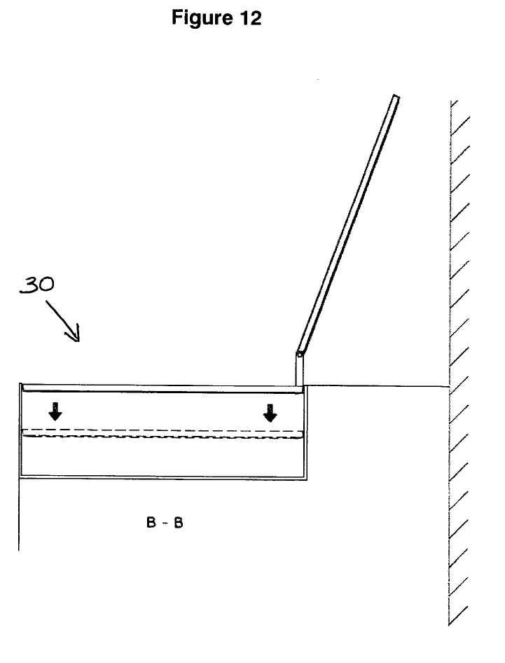

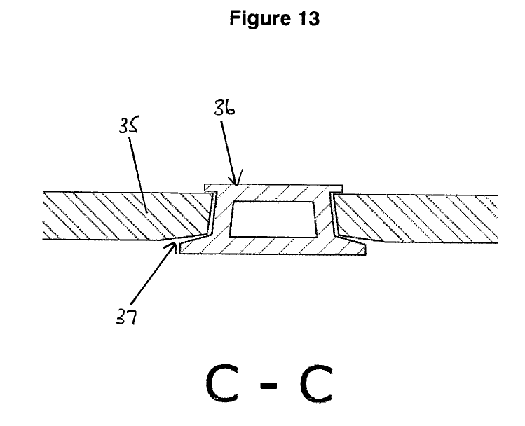

With respect to FIGS. 9 to 13, there is shown a cooking apparatus 30 set in the bench. The cooking apparatus 30 is a modular unit and there may be two or more cooking apparatus 30 set in the bench. The controls 31 for the cooking apparatus 30 are adjacent their respective cooking apparatus 30. The cooking apparatus 30 has a lower frame 32 set in the bench and upper frame 33 hinged to the lower frame 32. Each of the frames 32,33 have a recess 34 for the placement of plates 35. The periphery 36 around the recess 34 is raised to provide a space between the plates 35 when they are closed. The plates 35 are held in position within a groove 37 of the recess periphery 36 as shown in FIG. 13.

The cooking apparatus 30 set in the bench has an automated washing system which operates when the upper frame and lower frame are closed. The automated washing system uses 100 ml of water per 15 second wash and is used on heated platens which have a temperature between 120 and 150 degrees Celsius. The water is sprayed from a spray jet in a flat fanned shape and immediately turns to steam on contact with the heated platens. The steam condenses and removes carbonized waste and the waste water is drained via an adjacent channel to the plumbed waste water outlets.

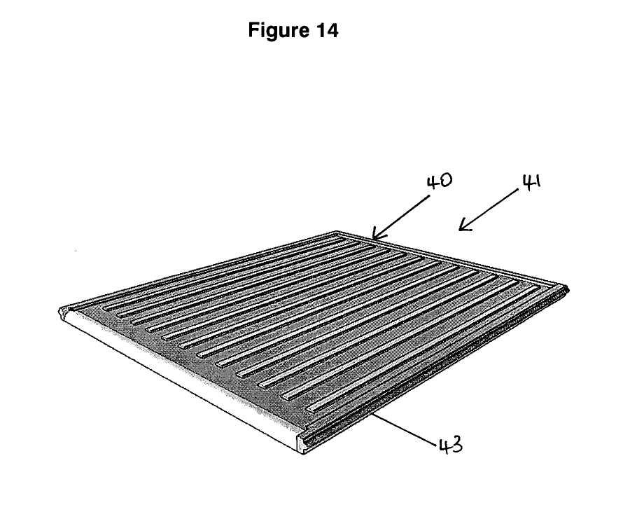

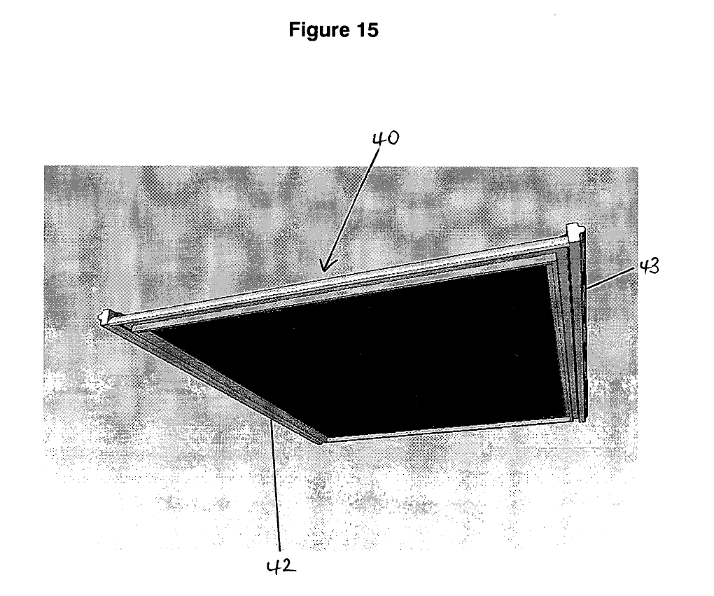

With reference to FIGS. 14 and 15 there is shown a plate 40 comprising a ribbed platen 41, thin film element 42, and side rails 43 for sliding engagement with the frame of a cooking apparatus. Each of the plates is made of mica that maintains insulator properties at high temperatures between 300 and 500 degrees Celsius. A thin film graphite element sandwiched between mica sheets is either laminated on the rear side of the mica plate or made integral with the mica plate during its manufacture. Other types of non-metallic plates can be used including: a nano-glazed lightweight ceramic plate which provides a non-stick and non-toxic cooking surface: a silicon carbide or a silicon carbide-ceramic composite plate having the advantage of withstanding very high temperatures, and a mica composite plate which has very good insulation properties.

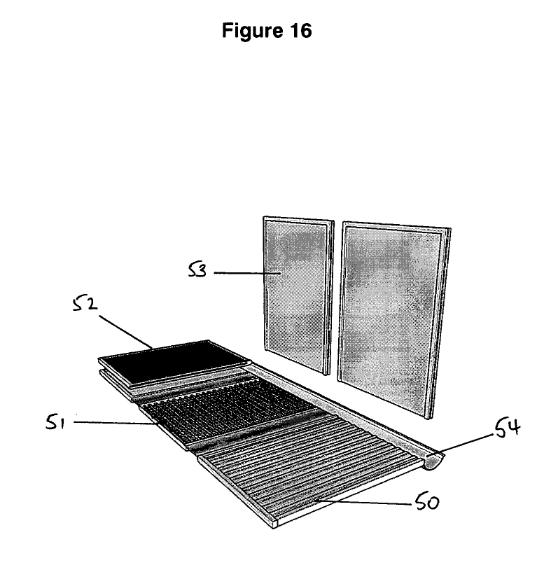

With reference to FIG. 16, there is shown the use of interchangeable plates with different types of platen patterns. The char grill platen 50 has thicker raised ribs for cooking and branding of meat products. The char grill platen 50 is made of high temperature ceramics. The waffle platen 51 is also made of ceramic material and is used with fine dining. The plainer grill 52 is made of nano-glazed ceramics or low alkaline ceramic glass. The upper plates 53 are preferably transparent and can be made of pyroceramic glass or mica. It is also shown a drainage channel 54 at the rear of the plates.

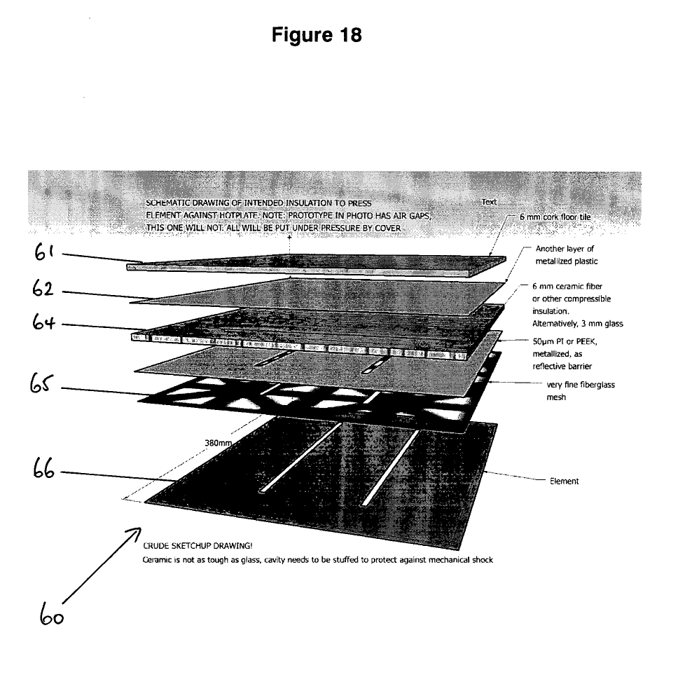

FIG. 18 shows the layers of a thin film element 60 there is a series of insulation layers that will be adjacent the rear side of the platen and serve to protect the thin film element from thermal fatigue from the heated platen. With thermal fatigue the thin film element will breakdown and will no longer heat the platen. Layer 61 is a 6 mm cork tile. Layer 62 is a metallized plastic. Layer 63 is a 6 mm ceramic fiber or other compressible insulation. Layer 64 is a 50 micrometer PI or PEEK metalized reflective barrier. Layer 65 is a very fine fiber mesh and layer 66 is the graphite element.

The following are a list of the properties and characteristics of the plates made from the selected materials:

| | Surface- | | | |
|---|---|---|---|---|
| | coated | | | |
| | Pyroceramic | Non-stick | Reinforced | Silicon |
| plate material | glass | ceramic | ceramic | Carbide |
| Temperature | Currently under | 450° C. | SiC whiskers or | In furnaces and as |
| range | 250° C. | | other nano-fibers | rod elements to |
| | New low alkali | | to strengthen | 1500° C. |
| | pyroceramic glass | | ceramic plates or | |
| | under 350° C. | | castings | |
| | | | 1000° C. | |
| Surface design | Available flat and | Cast or moulded | Cast as normal | Char grill ribs or |
| | ribbed (generally | in flat or ribbed | into complex | waffle patterns, |
| | used on top, with | tiles. Very | shapes. | edges and other |
| | sandwiches and | flexible. Generally | | detail can be cast |
| | light foods) | needs supporting | | or moulded into |
| | | “feet” on | | sintered platens |
| | | underside | | |
| Thermal shock | 700-900° C. | 1200° C. | Excellent | Not advisable to |
| capacity | | | | quench; may |
| | | | | develop fractures |
| Defects | De-vitrification | Brittle, needs | High cost, due to | If too thin may be |
| | after long | support and | SiC whisker raw | brittle. |
| | exposure to | cushioning. | material price | Reaction sintered |
| | (fluctuating) high | Glaze may spall | | SiC may warp in |
| | temperatures. | or delaminate | | furnace. |
| | Surface damage | | | Lower cost |
| | from carbonized | | | process porous. |
| | foods | | | |
| | Can be shattered | | | |
| | by edge blows | | | |
| | Scratched by | | | |
| | scouring | | | |
| Size limits | 2000 × 2000 mm; | 330 × 460 × 4 mm | | ~330 × 400 mm |
| | standard sheet | (minimum | | preferred 5 mm or |
| | 1150 × 840 mm | thickness); 5-6 | | more thick |
| | 2-16 mm thick | preferred | | |
| Strengths | Very strong, | Excellent non- | Self-repair of | Regularly used for |
| | especially if | stick cooking | micro-cracks | armour plating. |
| | laminated. | surface, can be | Silar AlO2/SiC | Very strong. Best |
| | | scoured | ceramic from ACS | product for high |
| | | | heat very rapidly | temperature units |
| | | | in MW | such as char grills |
| Current coating | Titania for self- | NanoGlaze | Can be glazed | Difficult to achieve |
| technology | cleaning, | proprietary | | adhesion due to |
| | disinfection and | recipes that may | | hardness. Several |
| | water sheeting, | include a large | | meethods |
| | Low ε glass, | range of oxides. | | available, |
| | including those | | | including laser. |
| | transparent to Far | | | Can be deposited |
| | infrared (FIR). | | | as transparent |
| | Heat reflective | | | thin films, which |
| | coating. | | | are |
| | Transparent | | | semiconductors |
| | conductive | | | with variable |
| | coatings like | | | resistance. |
| | (doped) ITO | | | |
| | Diamond-like | | | |
| | carbon for | | | |
| Proposed unique | Silicon carbide or | | | |
| syrface | other tough and | | | |
| treatment/s | durable easy | | | |
| | clean thin film for | | | |
| | hotplate | | | |
| Proposed or | Transparent top | Non-toxic, non- | Possible use in | High temperature |
| proven unique | hotplate | stick grill and | MW ovens; very | constant running, |
| benefit | assemblies so | char-grill | rapid heat from | reasonably easy |
| | food is visible | hotplates | conversion of MW | to clean |
| | during cooking | | energy: | |

### VARIATIONS

It will of course be realised that while the foregoing has been given by way of illustrative example of this invention, all such and other modifications and variations thereto as would be apparent to persons skilled in the art are deemed to fall within the broad scope and ambit of this invention as is herein set forth.

Throughout the description and claims this specification the word “comprise” and variations of that word such as “comprises” and “comprising”, are not intended to exclude other additives, components, integers or steps.

1. A cooking apparatus including
two non-metal plates operatively associated with each other, each non-metal plate has a non-metal platen and an integral or bonded thin film element, the non-metal platen is made from material selected from nano-ceramic, pyroceramic glass, ceramic reinforced with silicon carbide, silicon carbide or mica composite;
a frame having an upper portion pivotally mounted to a lower portion, each of said portions supports one of said non-metal plates wherein in use the non-metal platens oppose each other; and
control means for controlling the electrical current to the thin film element, wherein the plates can heat to temperatures between 300° C. and 450° C.

2. A cooking apparatus as claimed in claim 1 wherein the non-metal plates are preferably thinner plates compared with metal plates that can be heated to temperatures between 300° C. and 450° C.

3. A cooking apparatus including
two non-metal plates pivotally attached to each other, each non-metal plate has a non-metal platen and an integral or bonded thin film element, the non-metal platen is made from material selected from nano-ceramic, pyroceramic glass, ceramic reinforced with silicon carbide, silicon carbide or mica composite, each of said plates is replaceable, each of said plates has a groove or rail around its periphery;
a frame having an upper portion pivotally mounted to a lower portion, each of said portions supports one of said non-metal plates wherein in use the non-metal platens oppose each other; each of said portions has a recess and complementary groove or rail surrounding or partially surrounding the recess for mounting the plates; and
control means for controlling the electrical current to the thin film element, wherein the plates can heat to temperatures between 300° C. and 450° C.

4. A cooking apparatus as claimed in claim 1 wherein plates are mounted by sliding the plate in position by a tongue and groove arrangement or positioning the plate on a rail surrounding or partially surrounding the recess within the portions.

5. A cooking apparatus as claimed in claim 1 wherein the plates or the periphery of the frame recesses has a shield that forms a space for cavity between the plates when they are closed.

6. A cooking apparatus as claimed in claim 1 wherein there is also a washing means which includes a channel on the rear of the plate, front of the plate or between a series of plates and a spray jet that can spray water into the enclosed cavity of the cooking apparatus onto the plates of a closed cooking apparatus.

7. A cooking apparatus as claimed in claim 1 wherein there is one or more optional shields that can be placed on or in association with the plates to define a cavity that can serve as an oven.

8. A cooking apparatus as claimed in claim 1 wherein the plate is a reversible plate having the following layers: a platen, a thin film heating element, laminated insulation in a mirror image format using thin firm reflectors, thin film heating element, and platen.

9. A cooking apparatus as claimed in claim 1 wherein the cooking apparatus forms a modular unit and can be joined with other cooking apparatus in different configurations to suit kitchen requirements.
